(19) United States
(12) Patent Application Publication
(10) Pub. No.: US 2009/0289563 A1
(43) Pub. Date: Nov. 26, 2009

(54) Circuit Arrangement and Method for Operating At Least One Dielectric Barrier Discharge Lamp

(75) Inventor: Harald Dellian, Edling (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 11/989,998

(22) PCT Filed: Aug. 4, 2006
(86) PCT No.: PCT/EP2006/007754

§ 371 Date: Feb. 5, 2008

(30) Foreign Application Priority Data
Aug. 8, 2005 (DE) 10 2005 037 352.6

(51) Int. Cl. H05B 41/36

(52) U.S. Cl. 315/224

(57) ABSTRACT

The invention relates to a circuit assembly for operating at least one dielectrically impeded discharge lamp (La1) comprising an isolating transformer that is equipped with a switch (T1) in order to generate an operating signal for the at least one dielectrically impeded discharge lamp (La1) as well as a triggering circuit (14) for the switch (T1), which is configured so as to supply a pulse width-modulated square wave signal to the switch (T1). The switch-on times of the pulse width-modulated square wave signal depend upon the value of the resistance (R1, R2, R3) of a resistor assembly (20) that is connected to the triggering circuit (14), the value of the resistance (R1, R2, R3) of the resistor assembly (20) being provided with at least one time-dependent component (RT3). Also disclosed is a method for operating at least one dielectrically impeded discharge lamp (La1) on such a circuit assembly.

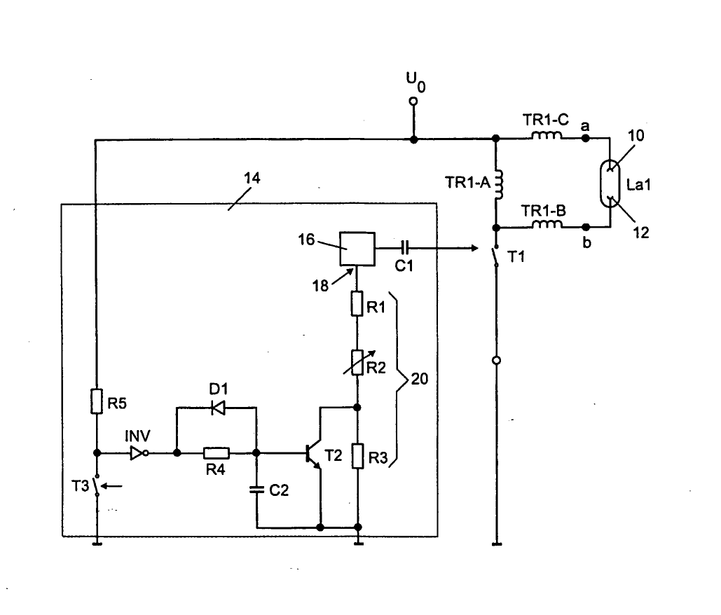

### TECHNICAL FIELD

The present invention relates to a circuit arrangement for operating at least one dielectric barrier discharge lamp having a flyback converter, which has a switch, for generating an operating signal for the at least one dielectric barrier discharge lamp, and a drive circuit for the switch, which drive circuit is designed to provide a pulse width modulated square-wave signal at the switch, the switch-on durations of the pulse width modulated square-wave signal being dependent on the value for the resistance of a resistance arrangement connected to the drive circuit. It also relates to an operating method for at least one dielectric barrier lamp using such a circuit arrangement.

### PRIOR ART

U.S. Pat. No. 6,323,600 B1 has disclosed the design and operation of such a circuit arrangement and such a method. In this case, the flyback converter has a DC voltage source, a transformer and terminals for a dielectric barrier discharge lamp. By varying the switch-on durations of the pulse width modulated square-wave signal applied to the switch of the flyback converter, the energy injected into the transformer can be varied. The longer the switch-on duration of the pulse

width modulated square-wave signal, the greater the energy provided to the dielectric barrier discharge lamp.

### DESCRIPTION OF THE INVENTION

The present invention relates to the problem of dimming a dielectric barrier discharge lamp. Dimming a dielectric barrier discharge lamp is previously unknown, but is in principle possible since an initial capacitance existing between the electrodes prior to starting breaks down after starting and therefore the lamp can be operated using little energy, i.e. dimmed. In this case, it is in particular desirable for the dimming setting to be retained once the discharge lamp has been switched off. This results in the problem that, when switching on in the dimmed state of the discharge lamp, the energy provided to the lamp in accordance with the dimming setting by the circuit arrangement known from the prior art is insufficient for starting the discharge lamp.

The object on which the present invention is based therefore consists in developing the generic circuit arrangement or the generic method such that it is possible to switch on a dielectric barrier discharge lamp in the dimmed state.

This object is achieved according to the invention by a circuit arrangement having the features of patent claim 1 and by an operating method having the features of patent claim 10.

The present invention is based on the knowledge that the abovementioned object can be achieved if the value for the resistance of the resistance arrangement has at least one time-dependent component. This makes it possible, for the purpose of starting the lamp, for the value for the resistance of the resistance arrangement to be increased for a short period of time and, directly after starting, to be brought back to the value

for the resistance of the resistance arrangement which corresponds to the dimming setting at the time at which the circuit arrangement was switched off. This makes it possible, depending on the dimensions of the circuit arrangement, for the lamp to virtually be switched on in its dimming setting in the eyes of a user. The short period of time during which the lamp is operated at a higher energy level in order to allow for starting can be set to be so brief that it is barely noticed, or even not noticed at all, by a user.

One preferred embodiment therefore furthermore comprises a timing element in order to shut down the time-dependent component after a predeterminable period of time. The timing element may be in the form of, for example, an RC element.

Depending on the field of application of the lamp, provision may furthermore be made for the shutdown process of the time-dependent component to be carried out suddenly or with a temporal transition phase once the predeterminable period of time has expired. A temporal transition phase may be advantageous when the intention is to provide an adaptation phase for the human eye to the dimmed state.

The predeterminable period of time is preferably less than 200 ms, preferably 20 ms to 200 ms and in particular 40 ms to 100 ms. The temporal transition phase is preferably up to 200 ms, preferably 30 to 100 ms.

The resistance arrangement furthermore preferably comprises a time-independent component, which comprises a predeterminable basic resistance value and a predeterminable dimming resistance value, which is dependent on a dimming setting of the circuit arrangement. In this case, the basic resistance value is preferably constant, and the dimming resistance value can be adjusted between a minimum value and a maximum value. This provides the possibility of dimensioning the time-dependent resistance value, the basic resistance value and the dimming resistance value such that, on the one hand, the sum of the time-dependent resistance value, the basic resistance value and the maximum dimming resistance value gives a power output of the flyback converter which is below a predeterminable limit, and, on the other hand, the sum of the time-dependent resistance value, the basic resistance value and the minimum dimming resistance value gives a power output of the flyback converter which allows for starting of the at least one dielectric barrier discharge lamp. The first-mentioned dimensioning specification ensures that only the provision of an energy level which is below a predeterminable limit and therefore does not result in any damage to the circuit arrangement is demanded in the starting phase of the lamp of the circuit arrangement. The second-mentioned dimensioning specification ensures that, even in the case of maximum dimming of the lamp, which corresponds to a minimum dimming resistance value, an energy level which is sufficient for starting the discharge lamp is provided at the discharge lamp.

The dimming resistance value and the basic resistance value may be realized, for example, by a potentiometer, which corresponds in terms of its minimum setting to the resistance value which consists of the basic resistance value and the minimum dimming resistance value and, in terms of its maximum setting, to the resistance value which results from the basic resistance value and the maximum dimming resistance value.

In one preferred embodiment, the time-dependent resistance value is 50% to 70% of the maximum dimming resistance value.

The preferred embodiments and advantages proposed with reference to the circuit arrangement according to the invention apply in a corresponding manner to the operating method according to the invention.

### BRIEF DESCRIPTION OF THE DRAWING

One exemplary embodiment of a circuit arrangement according to the invention will now be described below with reference to the attached drawing, which shows a schematic illustration of a preferred exemplary embodiment of a circuit arrangement according to the invention.

### PREFERRED EMBODIMENT OF THE INVENTION

The FIGURE shows a schematic illustration of one exemplary embodiment of a circuit arrangement according to the invention. In this case, a lamp La1, which is connected between the terminals a, b, is operated from a circuit arrangement having a flyback converter topology. For this purpose, a transformer, which comprises the windings TR1-A, TR1-B, TR1-C, and a switch T1 are arranged between a DC voltage source U₀, which may be, for example, 12 V or 24 V, and a reference potential. The design and operation of this part of the circuit arrangement according to the invention are described in detail in DE 197 31 275.6.

If the switch T1 is in the on state, essentially the DC voltage U₀ is present at the primary winding TR1-A, and a current, which rises linearly with time and reaches its peak value Iₘₐₓ at the end of the switch-on duration of the transistor T1, flows through the primary winding TR1-A and the switch T1. At this time, the electrical energy W

W=0.5·L_{P}·Iₘₐₓ²

is stored in the magnetic field of the primary winding TR1-A with the inductance L_{P}.

During the off phase of the switch T1, the electrical energy W stored in the magnetic field of the primary winding TR1-A is allowed to decay and is essentially output to the lamp La1. The lamp La1, owing to its dielectrically impeded electrodes 10, 12, has a capacitance which

is not negligible of the variable C_{L} and, together with the primary winding TR1-A, forms a resonant circuit.

With the aid of the secondary winding TR1-B, the voltage amplitude U_{P} of the voltage pulses is stepped up at a ratio n_{S}/n_{P} of the turns n_{S} of the secondary windings TR1-B, TR1-C to the turns n_{P} of the primary winding TR1-A to the value U_{S}

$${U}_{S} = \frac{{n}_{S }}{{n}_{P}} \cdot {U}_{P} .$$

A voltage pulse having the voltage amplitude U_{S} is therefore available as the operating or starting voltage at the discharge lamp La1. During the off phase of the switch T1, the discharge lamp La1 has voltage pulses having a positive polarity applied to it. The switch T1 operates at a clock frequency of approximately 25 kHz to 100 kHz. Accordingly, the lamp La1 has voltage pulses applied to it which have a pulse repetition rate of approximately 25 kHz to 100 kHz.

A square-wave signal which is pulse width regulated in this manner is preferably used, the switch-off durations being constant, and the switch-on durations varying. A drive circuit 14, which has a voltage-controlled oscillator (VCO), which applies its output signal to the switch T1 via a coupling capacitor C1, is used for generating the square-wave signals. The switch-on durations of the square-wave signal provided at the output of the voltage-controlled oscillator 16 are dependent on the resistance value for a resistance arrangement 20 connected at the input 18 of the VCO 16. The resistance arrangement 20 comprises a basic resistance value R1, a dimming resistance value R2 and a time-dependent resistance value R3. The time controller for the time-dependent resistance value R3 in this case comprises a capacitor C2, which is applied to the base-emitter path of a bipolar transistor T2 and

can be charged via a resistance R4, which is connected in parallel with a diode D1. For this purpose, the parallel circuit comprising the resistance R4 and the diode D1 is connected to the output of an inverter INV, which is connected on the input side, on one side, to the voltage source U₀ via a resistance R5 and, on the other side, to the ground potential via a switch T3, which can be opened or closed by an operator.

Operation: if the operator closes the switch T3 in order to switch on the discharge lamp La1, the input of the inverter INV is connected to the ground potential. At its output, a predeterminable voltage signal, for example 5 V, is therefore provided. The capacitor C2 is initially still uncharged, as a result of which the transistor T2 is in the off state. Accordingly, the sum of the basic resistance value R1, the dimming resistance value R2, which is set when the lamp is switched off, and the time-dependent resistance value R3 is present at the input 18 of the VCO 16. Given suitable dimensions, the sum of these three resistance values is sufficiently high for a pulse width modulated square-wave signal to be applied to the switch T1, with the result that sufficient energy is provided to the lamp La1 for the purpose of starting the lamp La1. Then, the capacitor C2 is charged via the resistance R4, it being possible for the time constant resulting from this to be established by suitably dimensioning the resistance R4 and the capacitor C2. As soon as the voltage at the capacitor C2 is sufficiently high in order to switch the switch T2 into the on state, the total resistance of the resistance arrangement 20 is reduced to the sum of the basic resistance value R1 and the dimming resistance value R2. As a result, the VCO 16 provides a pulse width modulated square-wave signal at the switch T1, which square-wave signal corresponds to the supply to the lamp La1 with an energy level corresponding to the dimming setting of the resistance R2 at the time at which the lamp La1 was last switched off.

The diode D1 is used for discharging the capacitor C2 in the case of the switch T3 being closed and opened in quick succession, with the result that, during the next switch-on process, i.e. closing of the switch T3, the capacitor C2 is discharged again in order to provide the predetermined time constant which is established by the dimensions of the resistance R4 and the capacitor C2.

1. A circuit arrangement for operating at least one dielectric barrier discharge lamp (La1) having a flyback converter, which has a switch (T1), for generating an operating signal for the at least one dielectric barrier discharge lamp (La1), and a drive circuit (14) for the switch (T1), which drive circuit is designed to provide a pulse width modulated square-wave signal at the switch (T1), the switch-on durations of the pulse width modulated square-wave signal being dependent on the value for the resistance (R1, R2, R3) of a resistance arrangement (20) connected to the drive circuit (14),
characterized
in that the value for the resistance (R1, R2, R3) of the resistance arrangement (20) has at least one time-dependent component (R3).

2. The circuit arrangement as claimed in claim 1,
characterized
in that it furthermore comprises a timing element (C2, R4) in order to shut down the time-dependent component (R3) after a predeterminable period of time.

3. The circuit arrangement as claimed in claim 2,
characterized
in that the shutdown process of the time-dependent component (R3) takes place suddenly or with a temporal transition phase once the predeterminable period of time has expired.

4. The circuit arrangement as claimed in claim 2,
characterized
in that the predeterminable period of time is less than 200 ms, preferably 20 ms to 200 ms, in particular 40 ms to 100 ms.

5. The circuit arrangement as claimed in claim 2,
characterized
in that the temporal transition phase is up to 200 ms, preferably 30 ms to 100 ms.

6. The circuit arrangement as claimed in claim 1,
characterized
in that the resistance arrangement (20) furthermore comprises a time-independent component (R1, R2), which comprises a predeterminable basic resistance value (R1) and a predeterminable dimming resistance value (R2), which is dependent on a dimming setting of the circuit arrangement.

7. The circuit arrangement as claimed in claim 6,
characterized
in that the basic resistance value (R1) is constant, and the dimming resistance value (R2) can be adjusted between a minimum value and a maximum value.

8. The circuit arrangement as claimed in claim 7,
characterized
in that the time-dependent resistance value (R3), the basic resistance value (R1) and the dimming resistance value (R2) are dimensioned such that, on the one hand, the sum of the time-dependent resistance value (R3), the basic resistance value (R1) and the maximum dimming resistance value (R2) gives a power output of the flyback converter which is below a predeterminable limit, and, on the other hand, the sum of the time-dependent resistance value (R3), the basic resistance value (R1) and the minimum dimming resistance value (R2) gives a power output of the flyback converter which allows for starting of the at least one dielectric barrier discharge lamp (La1).

9. The circuit arrangement as claimed in claim 6,
characterized
in that the time-dependent resistance value (R3) is 50% to 70% of the maximum dimming resistance value (R2).

10. An operating method for at least one dielectric barrier lamp (La1) using a circuit arrangement having a flyback converter, which has a switch (T1), for generating an operating signal for the at least one dielectric barrier discharge lamp (La1), and a drive circuit (14) for the switch (T1), which drive circuit is designed to provide a pulse width modulated square-wave signal at the switch (T1), the switch-on durations of the pulse width modulated square-wave signal being dependent on the value for the resistance (R1, R2, R3) of a resistance arrangement (20) connected to the drive circuit (14),
characterized
in that the value for the resistance (R1, R2, R3) of the resistance arrangement (20) is varied in a time-dependent manner.

11. The circuit arrangement as claimed in claim 3,
characterized
in that the predeterminable period of time is less than 200 ms, preferably 20 ms to 200 ms, in particular 40 ms to 100 ms.

12. The circuit arrangement as claimed in claim 3,
characterized
in that the temporal transition phase is up to 200 ms, preferably 30 ms to 100 ms.

13. The circuit arrangement as claimed in claim 4,
characterized
in that the temporal transition phase is up to 200 ms, preferably 30 ms to 100 ms.

14. The circuit arrangement as claimed in claim 2,
characterized
in that the resistance arrangement (20) furthermore comprises a time-independent component (R1, R2), which comprises a predeterminable basic resistance value (R1) and a predeterminable dimming resistance value (R2), which is dependent on a dimming setting of the circuit arrangement.

15. The circuit arrangement as claimed in claim 3,
characterized
in that the resistance arrangement (20) furthermore comprises a time-independent component (R1, R2), which comprises a predeterminable basic resistance value (R1) and a predeterminable dimming resistance value (R2), which is dependent on a dimming setting of the circuit arrangement.

16. The circuit arrangement as claimed in claim 4,
characterized
in that the resistance arrangement (20) furthermore comprises a time-independent component (R1, R2), which comprises a predeterminable basic resistance value (R1) and a predeterminable dimming resistance value (R2), which is dependent on a dimming setting of the circuit arrangement.

17. The circuit arrangement as claimed in claim 5,
characterized
in that the resistance arrangement (20) furthermore comprises a time-independent component (R1, R2), which comprises a predeterminable basic resistance value (R1) and a predeterminable dimming resistance value (R2), which is dependent on a dimming setting of the circuit arrangement.

18. The circuit arrangement as claimed in claim 7,
characterized
in that the time-dependent resistance value (R3) is 50% to 70% of the maximum dimming resistance value (R2).

19. The circuit arrangement as claimed in claim 8,
characterized
in that the time-dependent resistance value (R3) is 50% to 70% of the maximum dimming resistance value (R2).
